(19) United States
(12) Patent Application Publication
(10) Pub. No.: US 2008/0087698 A1
(43) Pub. Date: Apr. 17, 2008

(54) APPARATUS AND METHOD FOR CONTAINING AND TRANSPORTING ARTICLES

(76) Inventors: MARK L. CAMPBELL, Phoenix, AZ (US); WADE GIBBONS, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/955,033

(22) Filed: Dec. 12, 2007

Related U.S. Application Data
(63) Continuation of application No. 10/812,772, filed on Mar. 30, 2004, now abandoned.

(51) Int. Cl. B60R 11/00; B60R 11/06

(52) U.S. Cl. 224/282; 296/37.6

(57) ABSTRACT

An exemplary apparatus and method for the containment and transportation of articles is disclosed as comprising inter alia a container (100) having a lid (120) and a receiving portion (110), where the lid (120) engages the receiving portion (110) to form an interiorly disposed containment volume. The container (100) may be secured and moveably attached to a mounting surface (210) with a releasable locking hinge (160) such that the container (100) may be positioned in various orientations. Disclosed features and specifications may be variously controlled, adapted or otherwise optionally modified to improve the security and convenience of containment or transportation for any application or operating environment. Exemplary embodiments of the present invention generally provide for the secure containment and transportation of construction and diagnostic field equipment, such as nuclear ground density gauges for example.

### FIELD OF INVENTION

The present invention generally concerns devices and methods for the substantially secure containment and transportation of articles; and more particularly, in various representative and exemplary embodiments, to containment and transportation of construction and/or diagnostic field equipment, such as nuclear ground density gauges.

### BACKGROUND

Technological advances in equipment used for modern construction have produced tools that are more susceptible to damage and have relatively high replacement costs. Additionally, the possession, transfer and maintenance of some of these tools may be regulated or otherwise monitored by government agencies. For example, nuclear ground density gauges have sensitive electronic components, may cost anywhere from $5,000 to $20,000, and their use in the United States is regulated by the Nuclear Regulatory Commission (NRC).

If a nuclear gauge becomes damaged during transport, it may need to undergo costly repairs or replacement. Alternatively, if a nuclear gauge is lost or stolen, in addition to requiring costly replacement, the owner may be fined for failing to comply with State and/or Federal regulations.

Departments of Transportation in several States have recently adopted standardized policies for securing nuclear gauges during transport. In accordance with the following requirements, nuclear gauges must be secured with at least two locks: (1) the gauge handle and case must be locked; (2) the exterior container surrounding the gauge case must be locked; and (3) the exterior container must be secured to the transport vehicle so that movement forward, backward, or side-to-side is no more than a quarter of an inch.

Conventional devices and methods for the transportation of nuclear ground density gauges have been inadequate; resulting in costly losses due inter alia to damage in transport, loss and/or theft. Accordingly, there exists a need to prevent, obstruct, deter or otherwise avoid damage, loss and/or theft of nuclear gauge devices. That notwithstanding, the same need to avoid damage, loss and/or theft extends more generally to any article that may be susceptible to relatively high replacement cost.

### SUMMARY OF THE INVENTION

In various representative aspects, the present invention provides an apparatus and method for the containment and transportation of articles. Exemplary features are generally disclosed as including a container having a lid portion and a receiving portion, where the lid portion is configured to engage the receiving portion to form an interiorly disposed containment volume. Exemplary features further provide a container that may be moveably and securely attached to a surface with a releasable locking hinge, wherein engagement of the container with the surface allows the container to be positioned in various orientations.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter a/ia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively illustrates a three-quarter, isometric view of a device in accordance with an exemplary embodiment of the present invention; and

FIG. 2 representatively illustrates a side view of the device generally depicted in FIG. 1 in accordance with another exemplary embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are generally used for distinguishing between similar elements and not necessarily for describing a sequential or chronological order. Moreover, the terms ‘front’, ‘back’, ‘top’, ‘bottom’, ‘over’, ‘under’, and the like, if any, are generally employed for descriptive purposes and not necessarily for comprehensively describing exclusive relative position or order. Skilled artisans will therefore understand that any of the preceding terms so used may be interchanged under appropriate circumstances such that various embodiments of the invention described herein, for example, are capable of operation in other orientations and environments than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely an apparatus and method for the substantially secure containment and transportation of nuclear ground density gauges, is provided as a specific enabling disclosure that may be readily generalized by skilled artisans to any application of the disclosed apparatus and method for the containment and transportation of other articles.

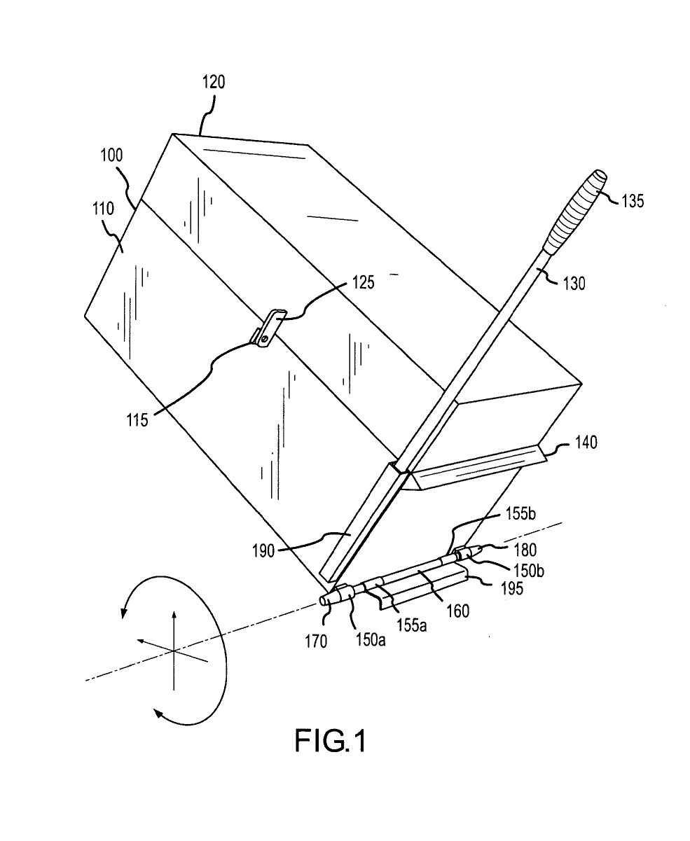

In accordance with an exemplary and representative embodiment of the present invention, FIG. 1 depicts a container device 100 suitably adapted for containment and/or transportation of, for example, nuclear ground density gauges. Container 100 comprises a upper lid portion 120 and a lower receiving portion 110. Upon engagement of lid 120 with receiving portion 110, a containment volume is generally defined therein.

Container 100 may provide a rectangular containment volume, as generally depicted for example in FIG. 1. Alternatively, conjunctively and/or sequentially, the containment volume may be configured to comprise any geometry, such as that of: a cube, a cylinder, a cone, a conic section, a sphere, etc. Additionally, the interiorly disposed containment volume may be molded or otherwise at least partially form-fitted for receiving articles of particular sizes and/or shapes therein. For example, in the case of a nuclear ground density gauge, the interior containment volume may be adapted to receive, isolate and/or otherwise contain discrete gauge parts or components. Alternatively, the containment volume may be suitably adapted for receiving a substantially unitary carrying case that houses a device such as, for example, a ground density gauge.

Lid portion 120 and receiving portion 110 may be configured with locking features (125 and 115 respectively) such that engagement of lid portion 120 with receiving portion 110 provides, for example, a through-hole for receiving a pad-lock to secure lid portion 120 to receiving portion 110 so as to prevent, deter or otherwise obstruct unauthorized access to the interiorly disposed containment volume therein. Skilled artisans will appreciate that a variety of locking and/or secure engagement mechanisms may be employed in order to obtain a substantially similar result. For example, any combination of the following elements may be alternatively, conjunctively and/or sequentially employed: a hinge, a flap, a hasp, a lock, a pin, a bolt, a rod, a dowel, a press fitting, a clip, a clasp, a hook, a button, a clamp, a tab, a clench, a grapple, a grip, a cam-lock, a bearing-lock, a knob, a knurled nut, a quick-release, and/or the like in addition to any engagement mechanisms whether now know or otherwise hereafter described in the art. Although not expressly represented in the Figures, lid portion 120 and receiving portion 110 may be pivotally engaged, for example, with a hinge such that lid portion 120 and receiving portion 110 may be brought into relative position to provide for substantially secure subsequent engagement.

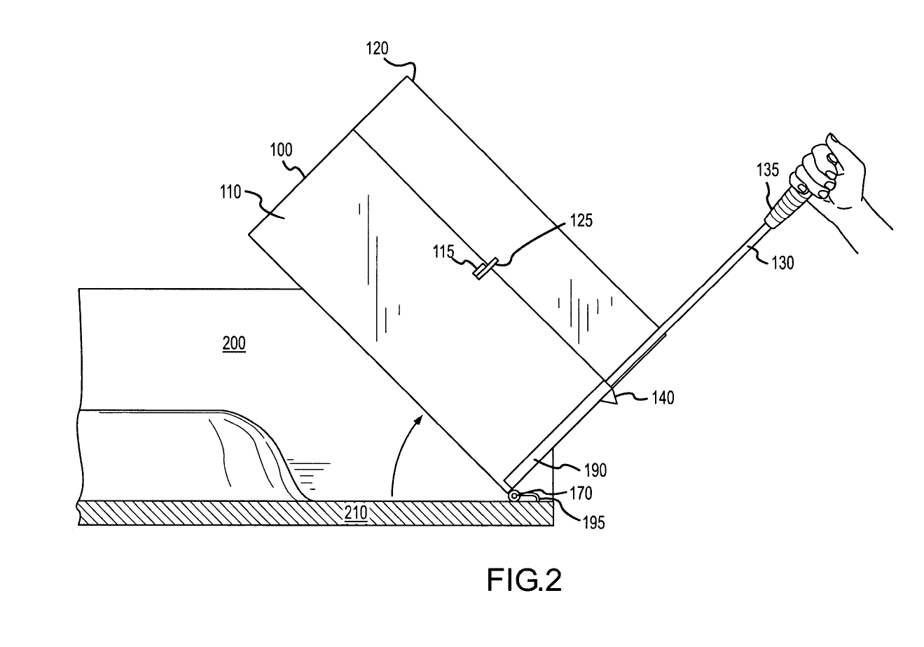

Container 100 may be configured with a releasable locking hinge bolt 160 for secure engagement with a storage and/or transport surface. In an exemplary embodiment, container 100 may be mounted to the bed 210 of a truck 200, as generally depicted, for example, in FIG. 2. Container 100 may comprise engagement hinges 150a, 150b that mate with surface hinges 155a, 155b of hinge plate 195 so as to receive locking hinge bolt 160 therethrough. After locking hinge bolt 160 is fitted with hinge cap 170 and hinge lock 180, container 100 is secured to surface 210.

In general, engagement of container 100 with surface 210 permits container 100 to be positioned in at least a first orientation and a second orientation. As representatively depicted in FIG. 2 for example, container may be rested on surface 210 or pivoted substantially 90 degrees from the resting position in order to allow access to the containment volume in a substantially vertical orientation. Skilled artisans will appreciate that a variety of other orientations may be selected to achieve a particular purpose.

Container 100 may also be optionally configured with a pull-rod receiving portion 190 and a pull-rod 130 to allow convenient positioning of container 100 in various orientations. Pull-rod 130 may also comprise a handgrip 135 or such other features that might tend to render pull-rod 130 more ergonomically adapted for a particular application and/or operating environment. An additional feature of pull-rod 130 is the ability to employ a mechanical advantage for moving heavy equipment; thereby avoiding, for example, potential workers compensation claims.

Container 100 may also comprise a stand-off feature 140, such as the corrugation or rail 140 generally depicted in FIG. 1, in order to promote inter alia stability while container 100 is positioned in a particular orientation. Skilled artisans will appreciate that a variety of stand-off components may be alternatively, conjunctively and/or sequentially employed, such as, for example: a leg, a peg, a nub, a corrugation, a finger, a post, a rail, a pad, a cushion, a spring, a shock absorbing element, and/or the like, in order to produce a substantially similar result.

Container 100 may be fabricated from any material now known or otherwise hereafter described in the art. In a representative embodiment, container 100 may comprise 16 gauge, diamond-plate aluminum. Diamond-plating may serve to ‘camouflage’ container 100 so that it is mistaken for a toolbox or an integrated vehicle compartment, for example. In other exemplary embodiments, diamond-plating and/or various other patterns, colors, etc. may be employed for aesthetic considerations and/or to association container 100 with a particular brand or intended use. Other gauges of aluminum, steel and/or the like may be used to manufacture container 100; however, in the event that container 100 is designed for containment or transportation of nuclear gauges, NRC regulations governing materials and thicknesses should be followed. For example, in the case of aluminum diamond-plate, the NRC requires sixteen (16) gauge as a minimum thickness. Skilled artisans will also appreciate that releasable locking hinge bolt 160 should be manufactured from a high strength material (such as high tensile steel and/or the like); a variety of materials may be alternatively, conjunctively and/or sequentially employed to achieve a hinge bolt 160 capable of securing the mass of container 100.

The exemplary embodiments of the present invention generally depicted in FIG. 1 and FIG. 2 presume that container 100 may be positioned in at least two orientations. No such limit, however, should be presumed for other embodiments of the invention. For example, container 100 may be adapted for positioning in three or more orientations. Alternatively, container 100 may be adapted to provide a single orientation for both loading and unloading, and/or storage and transportation. That is to say that in the appended claims, where at least two positional orientations of container 100 may be indicated, a first orientation may be identical or substantially equivalent to a second orientation. Indeed, in such a case where the first orientation is substantially equivalent to the second orientation, carrier 100 may be substantially immobile (translationally, rotationally, etc.) with respect to a mounting surface.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any device claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms ‘comprises’, ‘comprising’, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1.-20. (canceled)

21. A device for securely transporting an article on a surface, comprising:
a container, comprising:
a lid; and
a receiving portion configured to receive the article, wherein the lid engages the receiving portion and is configured to move between an open position and a closed position; and
a pivotable connector attached to an edge of the container and configured to attach to the surface, wherein the container may be rotated from a horizontal orientation to an upright orientation about the pivotable connector and about an axis substantially coincident with the edge.

22. The device of claim 21, further comprising a handle attached to the container and aligned substantially perpendicular to the axis.

23. The device of claim 22, wherein:
the container includes a corner extending substantially perpendicularly from the axis; and
the handle is attached to at least one of the cornet or a side of the container adjacent to the corner.

24. The device of claim 21, wherein the receiving portion includes:
a flat bottom portion, wherein the container rests on the flat bottom portion in the upright orientation; and
a flat back portion, wherein:
the container rests on the flat back portion in the horizontal orientation; and
the flat back portion shares a common edge with the flat bottom portion.

25. The device of claim 24, wherein the pivotable connector is attached to the common edge of the container.

26. The device of claim 21, wherein the lid is attached to the receiving portion by a hinge, wherein the hinge is substantially vertical when the container is in the upright orientation.

27. The device of claim 21, wherein the pivotable connector permits rotational movement about the axis and inhibits translational movement of the container.

28. The device of claim 21, wherein:
the receiving portion defines an interior cavity substantially form-fitted to a nuclear ground density gauge; and
the container comprises an exterior surface comprising diamond-plate aluminum having a thickness of at least sixteen gauge.

29. A device for securely transporting a nuclear gauge device on a surface of a vehicle, comprising:
a container configured to receive the nuclear gauge device; and
a rotatable connector attached along an edge of the container and configured to be securely coupled to the surface, wherein the container may be rotated about the rotation point from a horizontal orientation to an upright orientation.

30. The device of claim 29, further comprising a handle attached to the container and aligned substantially vertically when the container is in the horizontal orientation.

31. The device of claim 30, wherein:
the container includes a edge extending substantially perpendicularly from the rotatable connector; and
the handle is attached to at least one of the edge or a side of the container adjacent to the edge.

32. The device of claim 29, wherein the container includes:
a flat bottom portion, wherein the container rests on the flat bottom portion in the upright orientation; and
a flat back portion, wherein:
the container rests on the flat back portion in the horizontal orientation; and
the flat back portion shares a common edge with the flat bottom portion.

33. The device of claim 32, wherein the rotatable connector is attached to the common edge of the container.

34. The device of claim 29, wherein the container comprises a lid is attached to a receiving portion by a hinge, wherein the hinge is substantially vertical when the container is in the upright orientation.

35. The device of claim 29, wherein the rotatable connector permits rotational movement of the container about an axis and inhibits translational movement of the container.

36. The device of claim 29, wherein:
the container defines an interior cavity substantially form-fitted to a nuclear ground density gauge; and
The container comprises an exterior surface comprising diamond-plate aluminum having a thickness of at least sixteen gauge.

37. A device for securely transporting an article on a vehicle, comprising:
a container, comprising:
a lid; and
a receiving portion, wherein:
the lid portion engages the receiving portion to form at least one containment volume; and
the receiving portion includes:
a flat bottom portion, wherein the container rests on the flat bottom portion in an upright position; and
a flat back portion, wherein:
the container rests on the flat back portion in a reclined position; and
the flat back portion shares a common edge with the flat bottom portion;
a pivotable connector attached to the common edge of the container and configured to be attached to the vehicle, wherein the container may be rotated about the pivotable connector from the horizontal orientation to the upright orientation; and
a handle attached to the container and extending vertically when the container is in the reclined position.

38. The device of claim 37, wherein the handle is attached to an edge of the container extending perpendicularly from the pivotable connector.

39. The device of claim 37, wherein the pivotable connector permits rotational movement of the container about an axis and inhibits translational movement of the container.

40. The device of claim 37, wherein:
the container defines an interior cavity substantially form-fitted to a nuclear ground density gauge; and
the container comprises an exterior surface comprising diamond-plate aluminum having a thickness of at least sixteen gauge.
